(19) United States
(12) Patent Application Publication
(10) Pub. No.: US 2017/0315682 A1
(43) Pub. Date: Nov. 2, 2017

(54) GLOBAL VIRTUAL TRADE AND SOCIAL NETWORK

(71) Applicant: Nikolay ULYANOV, St. Petersburg (RU)

(72) Inventor: Nikolay ULYANOV, St. Petersburg (RU)

(21) Appl. No.: 15/497,483

(22) Filed: Apr. 26, 2017

Related U.S. Application Data
(60) Provisional application No. 62/328,057, filed on Apr. 27, 2016.

(51) Int. Cl. G06F 3/0482; G06Q 50/00

(52) U.S. Cl. CPC G06F 3/0482; G06Q 50/01

(57) ABSTRACT

The invention is a method and system of visualizing, presenting, and querying data so that it can provide a more even playing field for both searching users and providers of goods and services arranged in a territorial, categorical, floor, block and object view. This avoids the display of information as just a list of results wherein the list may often times not be sorted based on relevancy but rather which supplier has paid the most in order to have their result filter to the top of the list.

### CROSS-REFERENCE TO RELATED APPLICATIONS

The present application claims priority to U.S. provisional application No. 62/328,057 filed on Apr. 27, 2016, which is incorporated herein by reference.

### BACKGROUND OF THE INVENTION

### 1. Field of the Invention

The invention falls within the sphere of information technologies, namely, management (creation, editing, deletion, search, representation, etc.) of information stored in the Internet-based distributed data system. The technical result enables Visitors to satisfy their needs in the field of commercial and service, production, human and social relations through the functionalities of the Network.

### 2. Background Art

Among existing analogs of certain functionalities of the Global Virtual Trade and Social Network are the largest and most successful Internet projects in the field of e-commerce (Amazon.com, Alibaba.com, Aliexpress.com, eBay.com), social relations (Facebook.com, vk.com) and information search (Google.com, Yandex.ru). However, each of these projects, while solving certain field-specific issues, rules out any complex satisfaction of needs met by users in ordinary real life. Further, the majority of the above projects and their analogs provide information to end users in a chaotic, non-structured fashion, often imposing goods and services, ranking generated information by the amount of funds spent on promotion and advertising, which eventually neglects the end user's right to receive reliable information based on the quality of its content rather than the amount of funds spent to promote it.

The Global Virtual Trade and Social Network is designed as a unified global virtual center, where suppliers and consumers will be not merely brought together “under the same roof” (in fact, the Internet functions this way), but will be reasonably systematized, arranged, represented via new visual displays with a view to equal rights to granting and accessing information.

### SUMMARY OF THE INVENTION

The Network and system provides new opportunities for Suppliers and Visitors. An advantage of the present approach for Suppliers over traditional internet search and information gathering systems are as follows: a unique mechanism for promotion of Goods based on equal and transparent conditions of distribution; an opportunity not only to sell Goods as a “one-stop-shop” (through the Personal Account), but also to satisfy their business needs in an optimum manner, from staff recruitment to searching for the best terms for delivery of materials and provision of services for their company, by means of Network Services using Chaining mechanisms; and the ability to expand one's global reach by opening a virtual store in the localized market of another city or country so that one's business comes up as a result in searches.

In their turn, Visitors are given opportunities that help make their life easier, reduce costs and time spent on searching certain goods and services, receive goods and services at more attractive prices, have a wider choice of offers and the widest range, satisfy needs for human and social relations, as compared to other online solutions. Such advantages include: a unique mechanism of displaying search results with no need to look through dozens of pages of search results trying to find required information; a visitor is not forced to make any choice, all Network Members are on an equal footing and are visualized for users, unlike in conventional search engines, where priority is given to sellers of goods and services, which paid for high ranks and “rise-up” in search results; a visitor registered in the Network as an Apartment Owner, is given an opportunity to use its skills, competence, abilities and earn; to obtain information needed to satisfy its needs in a convenient way; to find new acquaintances, establish business and day-to-day communication, look for employers all over the world; any Network Member is given an opportunity to become a supervising partner of any Category (or several Categories) in a certain territory, to attract Suppliers having its share of revenues paid as rental charges.

Structure of the Network:

The Network is presented to Visitors as an Internet-based virtual world visually constituting a dynamic association of virtual high-rises—Towers.

Towers:

Towers are virtual structures visually constituting an image of a building (high-rise) divided into Floors. Towers are meant for placement of Network Objects grouped into Categories. Towers can vary based on a number of grounds taken together or separately: Territoriality, Purpose and Categories. Towers can be static and dynamic. An image of a static Tower is created based on the numbering of Network Objects used for identification (ref. Numbering in the Network). An image of a dynamic Tower is created on the basis of Visitors' Queries.

A consumer device can display from 1 to N static or dynamic Towers at a time (which is defined by capabilities of the consumer device). For example, a) 3 static Towers are displayed: Tower 1 (Territory: USA; Purpose: Goods), Tower 2 (Territory: USA; Purpose: Services), Tower 3 (Territory: USA; Purpose: Production); b) 1 static Tower is displayed: Tower 1 (Territory: USA; Purpose: Goods) chosen by a Visitor for further work; c) 2 dynamic (interactive) Towers are displayed resulted from the Visitor's Query: (To select all specialists and companies rendering design services in Towers with Purpose: Services, Advertisements): Tower 1 (Territory: everywhere; Purpose: Services), Tower 2 (Territory: everywhere; Purpose: Advertisements).

The Visitor can choose any Tower in any territory (country, planet, fantasy world) registered in the Network. For example, the Visitor can choose the Tower “USA”—“Goods”, which presents goods of US producers and all foreign businessmen willing to sell their products in the USA, or the Tower “Italy”—“Goods” and, thereby, purchase goods directly from sellers, suppliers and producers from Italy with no middlemen involved, etc.

Thus, the Network enables Suppliers to expand the geography of their business to the maximum making it possible to place Goods in Stores (Offices) in the territory of their interest, and Visitors can easily obtain information on targeted Goods in any territory included in the Network.

Floors:

Each Tower is made up of Floors. Floors accommodate Network Objects distributed by the Major Category assigned to them upon registration. The number of floors may vary depending on the scope of the Network. The range of floors is not fixed and can be changed as the Network functions.

Visually, Floors have a particular size and form (for example, square, rectangle, circle or any other complex shape), which can be changed as the Network functions. Each Floor can be visually divided into Blocks for easier perception. Besides, Tower Floors can be united in sectors for easier navigation, if a Tower is made up of a great number of Floors.

Each Network Object takes a certain Place, which is clearly located on the Floor and in the Network. Initially, the location of each Network Object is chosen by the Network Visitor, who registered this Object. Places taken by Network Objects can be visually similar or have different shape and size.

This way, the Network enables Network Members to create their own Network Object (Store, Classified, Office) using ready-made tools and modules, place there detailed information on Parameters of the Object (Goods, Advertisements, etc.) and locate the Network Object in the Tower Floor scheme.

Numbering in the Network:

It is a feature of the Network that it presents the entire international system of trade and services in a non-random manner. While Network Objects are given unique links—URLs to Internet resources in the Network, each Object is also assigned a unique number identifying the Object in the global virtual trade and social network.

The numeration in the Network is associated with a minimum indivisible virtual unit of Floor area measurement—Cell (Box). Cells are used to measure Floors and area of Places taken by Network Objects.

Each Cell has an assigned unique, within the Network, number. Cells are numbered in the following manner: XXX-YY-ZZZ-BB-NNN, where: XXX is a code of the territory, to which a Tower belongs (can be symbolic or numeric, can use international numeration systems or systems developed by the Network Administrator); YY is a code of the Tower Purpose; ZZZ is a code of the Tower Floor; BB is a number of the block on the Tower Floor; NNN is a digit number of the Cell in the Floor block.

Example of such numeration: 840-01-037-01-122.

The first digit block is the territory. In this case, it is a country code (USA) according to ISO 3166-1 numeric. Along with names of real countries, cities, regions and districts, the territory can have names of virtual territories generated by the Network Administrator. For example, Mars or Venus.

The second digit block specifies the Purpose of the Tower, where the Network Object is located. In this case, code 01 is fit for the Tower Purpose—Goods.

The third block is the number of the Tower Floor numerated top-down or bottom-up, which corresponds to the Major Category.

The fourth digit block is the serial number of the Cell block on the Floor.

The fifth digit block is the number of the Cell in the Floor block.

The number of the Network Object definitely corresponds to the number of the Place taken by the Network Object on the Floor. It should be noted that the number of the Place attached to the Network Object is assigned according to the number of the top left Cell forming part of the Place of the Network Object (or according to any other principle). However, all levels can have different orders of numbering. Symbols (digits and characters) may vary in their quantity depending on requirements of the Network.

The systematization introduced by the invention allows creating groups of Objects of interest united by their addresses (Stores, Offices of Service Providers and Producers of Goods, Classifieds, etc.) and introducing the concept of virtual territories (planet, island, country) for certain subject areas and new non-conventional categories of goods and services (for example, gadgets to-be, products to-be, etc.).

Interactive (Dynamic) Floors and Towers:

Floors and Towers can be formed upon a particular Query of a Visitor. When typing a query in the search box with certain criteria, categories, subcategories and features, for example, the city, categories of goods and services, the brand of goods, etc., the Visitor obtains search results in the format of a Floor (or Tower), which displays all Network Objects matching the search result criteria. The Visitor can select an interesting Network Object from those proposed, enter it and obtain full information on Parameters of the Object.

Sample Query to form an interactive Floor or Tower: the city of New York (city name is spontaneous). The Visitor types the word “New York” in the search box in the mode of Query construction and the system automatically selects all Network Objects (Stores, Offices of Service Providers and Producers, Classifieds) somehow associated with the city of New York. The Visitor gets search results focused on its needs in the form of one or more interactive (dynamic) Towers with Floors containing only those Network Objects that have the feature “New York” in their Parameters, while the location of Floors remains unchanged as system users know it.

By broadening search criteria, Visitors can narrow down Query results and obtain information best suited to their needs.

Visualization of Search Results and Navigation in the Network:

The main difference of the invention from ordinary e-commerce and search systems is a unique method of representation of information to end users, which makes it possible to see a lot of Network Objects of one Category at a time. It can be, for example, 100, 900 or more Network Objects (or any other quantity) depending on the scope of the Network, the configuration of Towers and their Floors. In this respect, all Network Objects are equally represented to Visitors and it is equally possible that consumers will choose any of the Objects. This way, the following aims are achieved: for Suppliers—a unique mechanism of promotion of Goods under equal and transparent conditions of distribution is implemented; for Visitors—a unique mechanism of display of search results is offered with no need to look through dozens of pages of search results trying to find required information and with no choice imposed, all Network Members are on an equal footing and are visualized to Visitors.

Navigation through resources of the Network is as follows.

The first way is similar to navigation through physical towers, shopping centers and other buildings in real life, when buyers just travel from store to store and study the range of products they offer. In this case, Visitors can select a Tower from a series of presented Towers, for example, having decided in what country they would like to make a purchase, then they travel to the targeted Floor. Selection of the required Floor with interface elements results in its displays in full screen and makes it possible to see the Floor scheme and work (look through, travel) with Network Objects (for example, Stores or Offices) located on the Floor. When selecting a Network Object on the Floor, Visitors switch to the interface for viewing Parameters of this Object (for example, they can study the product range, prices, terms of purchase and delivery, information on the Network Member owning the Object) and performing additional actions determined by the Network Member for this Object (choose goods or services they need, add them to the cart and make an order in the single cart, contact the Network Member, etc.).

The second way is the possibility to execute search Queries making it possible to optimize provision of required information and shift to the required Network Object. Sample Query: a Visitor looks for a plumber rendering its services in the city of Lyons, France. To do this, the Visitor selects France among the proposed countries (which is visualized as a Tower or any other virtual Building like all other territories), selects the Tower—Services. Then shifts to a Floor with offers of all locksmiths, pipe fitters and plumbers. Types “Lyons” in the search box and gets all masters in this sphere, who work in the city of Lyons. The search can be simplified. The user simply types “plumber in Lyons” in the search box and gets an interactive Floor with all offers in this sphere in the city of Lyon.

The third way is the use of conventional navigation systems found in most online stores, such as: searching by categories, in a search box, using filters, etc.

In addition to the above, Visitors can also create routes along Floors and Towers through various Network Objects, where they would like to make, for example, purchases or order services, successively travelling from one Network Object to another. In the meantime, Network Members can have statistics on preferences of Visitors, analyze their behavior in the Network and then, based on this information, improve the efficiency of business offers.

Apartment Tower:

The Apartment Tower is a central object of the Network constituting a virtual building, where any Visitor can have his or her personal space ensuring full use of the Network's resources and become an Apartment Owner. An Apartment is a range of interface elements used to fill it with information relevant for its Owner and services supporting interactions of the Apartment Owner with other Network Members.

Each Apartment has its unique address (number) within the Apartment Tower and the Network. The address of the Apartment is formed as follows: XXXXX-YY-NNN, where XXXXX is a code of the Floor in the Apartment Tower; YY is a code of the Apartment block on the Floor; NNN is a number of the Apartment in the Apartment Block. However, the quantity of digits and the composition of blocks in the number format may vary depending on requirements of the Network.

As an example, below you will find an Apartment number format for the Apartment Tower accommodating 9,000,000,000 Apartments: XXXXX-YY-NNN, where XXXXX is a five-digit number of the Floor in the Apartment Tower (ranging from 0 to 99,999); YY is a two-digit number of the Apartment block on the Floor (ranging from 0 to 99); NNN is a three-digit number of the Apartment in the Apartment Block (ranging from 1 to 900).

The unique Apartment address constitutes a mail box address granted to the Apartment Owner for personal use. The mail box is primarily meant for the Apartment Owner to receive and transfer information within the Network. The mail box solves the spam problem as it informationally unbinds the Apartment Owner's real e-mail address. All information is consolidated at the mail box level and only the Apartment Owner decides which information can be transferred to his or her personal mail, if needed.

Visiting various Network Objects, Apartment Owners can subscribe to newsletters on certain Goods or of certain companies supplying goods or rendering services. Subsequently, they will receive promotional and informational materials and information on available goods and discounts for selected items, cooperation offers or job offers, etc. The mail box helps Apartment Owners communicate with sellers of goods and service providers, request relevant information and send inquiries, for example, a request of discounted prices for any type of goods for all users, without disclosing their personal mail.

Apart from the mail box, Apartments may have additional integrated options, such as a personal profile for Apartment Owners; a calendar of events and sales, which are independently entered by Owners; a module of notes and documents, an image bank for any type and format of data, depending on Owners' needs; information bookmarks placed in the resource and in external resources, while Owners are doing shopping, searching for jobs and performing other actions in the Network. The content of Apartments is regulated by Owners; major modules can be added and removed. This way, every user builds its own personal apartment office with unique content to work in the Network.

The system “connects” these sections and provides Apartment Owners with aggregated information from the Apartment Tower and other Towers, which makes it possible to get a solution for own needs and make use of own skills. It should be noted that unlike various advertising systems, Abilities declared in Apartments are posted in the Network for an indefinite term at the sole discretion of Apartment Owners.

Moreover, each Apartment Owner has an Emergency Assistance (SOS) function, which can be secured by other Network Members. An Apartment Owner seeking assistance posts the relevant information and then receives ready-to-help responses from other Network Members. The search involves geolocation services, which help track Network Members within a radius of, for example, 500 meters that need help in the area of competence of any given Network Member. This service facilitates cooperation of people, their association and mutual help along with searching and forging of new contacts.

A similar algorithm can be found in other Towers. It is a partner search service helping some companies place their offers in various fields and other companies select suitable offers from proposed options and arrange direct contacts with potential partners, contractors or clients.

Chains:

The invention is featured by a Chaining mechanism. This mechanism makes it possible to store results of versatile Queries required to satisfy the needs of Network Members in their Private Accounts.

As an example, let us consider a situation, when an Apartment Owner makes repairs with no outside help. Along with purchase of materials, he or she may need an express delivery service in their region and various construction services of different specialists. To address this problem comprehensively, the Apartment Owner, by executing Queries, forms a Chain of Network Objects with information on materials acquired and services ordered in a structured, complex, easy-to-percept and easy-to-process manner. The Chain is stored in the Owner's Apartment and allows viewing the Chain at any time, checking elements of the Chain that fulfilled their purpose, editing initial chaining Queries and deleting the Chain.

Principles Used to Determine the Cost of Placement of Network Objects:

The basic principle used to determine the cost of placement of Objects in the Network is similar to the method applied in real-life property rental, i.e. the calculation of the cost considers the area rented by Network Members expressed as a number of Cells for each Network Object. The major formula for the calculation of rental costs is as follows: S=Σₙ₌₁^{k}(Ncₙ*Pc), where Ncₙ is a number of Cells for a particular Place, Pc is a rent price of the Cell for a certain period (month, quarter, half year, year), k is a number of Network Objects owned by a Network Member.

Additionally, various features of Object Parameters can be used in calculation of final rent prices for Network Members, for example, the quantity of goods placed in one Network Object or subscriptions to certain Network Services.

Terms and Definitions for the Present Application:

“Network Administrator” means a legal entity engaged in developing and establishing Network procedures and policy rules and responsible for management of the Network.

“Apartment” means an Object of the Network containing a range of information on Abilities, Needs, login and other details of an Apartment Owner and being managed by the Apartment Owner. Each Apartment has its own unique address within an Apartment Tower in the following format: XXXXX-YY-NNN, where XXXXX is a code of a Floor in the Apartment Tower; YY is a code of an Apartment block on the Floor; NNN is a digit number of an Apartment in the Apartment Block.

“Apartment Owner” means a Network Member, who registered in the Network to manage an Apartment.

“Tower (Building)” means a Network-based virtual structure visually constituting an image of a building (high-rise) divided into Floors and meant for placement of Network Objects grouped into Categories. Towers can vary based on a number of grounds: Territoriality, Purpose and Categories. The visual image of the tower can be created both statically and dynamically in response to Queries of a Visitor. The building can have from 1st to N Floors.

“Apartment Tower” means a Network-based virtual structure visually constituting an image of a building (high-rise) divided into Floors and meant for placement of Apartments. The total number of Apartments placed in the Apartment Tower is determined by the used Apartment address format.

“Global Virtual Trade and Social Network (Network)” means a distributed information management system that provides Network Visitors with access to data created by Network Members using Internet-connected consumer devices via special software for web-browsing (browser) or a Mobile Application.

“Query” means communication of a Visitor with the Network search engine established according to the rules set by the Network for certain Categories to obtain the information stored in Parameters of Network Object.

“Internet” means the global system of interconnected mainframe, personal, and wireless computer networks that use the Internet protocol suite (TCP/IP) to link billions of devices worldwide.

“Classified” means a Network Object taking a Place on Floors of an Advertisement Tower and featuring one or more Advertisements.

“Category” means a group of similar Goods united by any common features.

“Personal Account” means a Network Member's personal section in the Network associated with the Network Member's Login Details, where the Network Member can manage Network Objects and certain Network Services, inter alia, to order, activate/deactivate them under the terms stipulated by the Network.

“Store (Office)” means a Network Object taking a Place on a Tower Floor, containing a range of information on Goods in the Network and managed by a Supplier, and the Supplier's login and other details.

“Place” means visual display of the location of the Network Object on a Floor. The Place can be made up of one or more Cells and can be complex in its shape or form. The Place has a unique identification number assigned according to the number of the left top Cell forming part of the Place.

“Mobile Application” means a software component installed on a mobile device (phone, communicator, smartphone, etc.) for a certain mobile platform (Android, iOS, Windows Mobile, etc.), which connects to the Network and manages the device's user interface and business logic.

“Tower Purpose” means association of a Tower with a certain type of relations in the real world: commercial, service, social, production relations, etc. Based on their purposes, Towers can be called (including, but not limited to) Goods, Services, Advertisements, Work, Vacancies, etc.

“Network Object (Object)” means a virtual space created by a Network Member, linked to a certain Place on a Tower Floor or an Apartment in the Apartment Tower and featuring a range of Parameters that contain information describing the Object in a certain way.

“Advertisement” means a range of information messages of a Network Member offering Goods (including contact details, photos and any other related information) and addressed to the public at large.

“One-Storey Building” means a Tower made up of one (1) Floor.

“Major Category” means a Category chosen as major for a Network Object.

“Object Parameter (Parameter)” means an information feature of an Object enabling a Network Visitor to get an insight into the Network Object within the limits set by the Network Member owning the Network Object. Object Parameters can include, but not be limited to Categories, Advertisements, Subcategories, Abilities, Services, Skills, Territoriality and Goods.

“Subcategory” means a certain part or section of a Category.

“Network Visitor (Visitor)” means any visitor of Internet resources, including the Global Virtual Trade and Social Network.

“Supplier (Tenant)” means a Network Member registered in the Network to place information on Goods (Advertisement) in a Store (Office) or Classified to advertise them to the public at large.

“Needs” means services or works that a certain Network Member would like to get for free or for a certain charge.

“Registration” means a number of actions pursuant to the instructions specified in the Network, inter alia, provision of Login Details and any other information, performed by the Visitor using a special form of the Network user interface to create a Network Object and obtain access to certain Network Services.

“Service” means functional capabilities, utilities, features and tools available to Network Members.

“Network” ref. Global Virtual Trade and Social Network.

“Abilities” means expertise, skills, services and works, which can be provided by Apartment Owners to other Network Members for free or for a certain charge.

“Territoriality” means a parameter of a Network Object defining the geographic location, where Goods and Advertisements are available.

“Tower Territoriality” means affiliation of a Tower with a certain territory (country), which consumers (inhabitants) are targets for information placed in Network Objects marked this way.

“Goods” means any goods, product, service, work or any other offer, which is placed by a Network Member in a Network Object.

“Network Member” means a Network Visitor registered in the Network. Network Members include, but are not limited to Suppliers and Apartment Owners.

“Login Details” mean a unique login (e-mail address) and password created by a Network Member at its own discretion upon Registration in the Network or changed later by the Network Member through the Personal Account, used to access the Personal Account upon authorization of the Network Member in the Network.

“Chain” means a number of Queries forming in the end a range of Parameters of Network Objects enabling a Network Visitor to obtain any information needed to satisfy the Visitor's needs in the best possible (most optimum) way.

“Floor” means a range of Network Objects grouped by the Network Administrator in a certain Category and visualized in a single virtual template similar in its structure to a real floor of a building with isolated premises. Each floor can be made up of one or more virtual blocks. A floor block visually constitutes a square matrix N in size×N Cells.

“Cell (Box)” means an indivisible virtual unit constituting a spot of certain size and form on a virtual Floor. Each cell has a unique number assigned to it in the following format: XXX-YY-ZZZ-BB-NNN, where: XXX is a code of the territory, to which a Tower belongs; YY is a code of the Tower Purpose; ZZZ is a code of the Tower Floor; BB is a digit number of the block on the Tower Floor; NNN is a digit number of the Cell in the Floor block.

The system for global virtual trading on a network includes a server system with a processor system, a communications interface, a communications system, an input system and an output system, the server system having access to a communications network, a memory system with an operating system, a communications module, a web browser module, a global trade on a network non-transitory computer storage media, the global trade on a network non-transitory computer storage media residing on the memory system and a website with a plurality of web pages to manage the system for global trading on a network, the web pages reside on the global trade on a network non-transitory computer storage media. The system for global trading on a network further comprises a plurality of client systems that communicate with the server system via the communications network, which is the Internet.

### BRIEF DESCRIPTION OF THE DRAWINGS

The present invention will now be discussed in further detail below with reference to the accompanying figures in which:

FIG. 1 shows a tower.

FIG. 2 shows a territory of towers.

FIG. 3 shows a tower with floor.

FIG. 4 shows a tower with a different floor configuration.

FIG. 5 shows a view of a floor.

FIG. 6 shows a view of a floor.

FIG. 7 shows a view of a floor.

FIG. 8 shows a view of a floor with a preview of an object.

FIG. 9 shows the full information for a selected object.

FIG. 10 shows the business card interface.

FIG. 11 shows a dynamic business card.

FIG. 12 shows a floor with apartments for individuals.

FIG. 13 shows an individual's profile page interface.

FIG. 14 shows chaining by a user.

FIG. 15 is a high level system view.

### DETAILED DESCRIPTION OF THE PREFERRED EMBODIMENTS

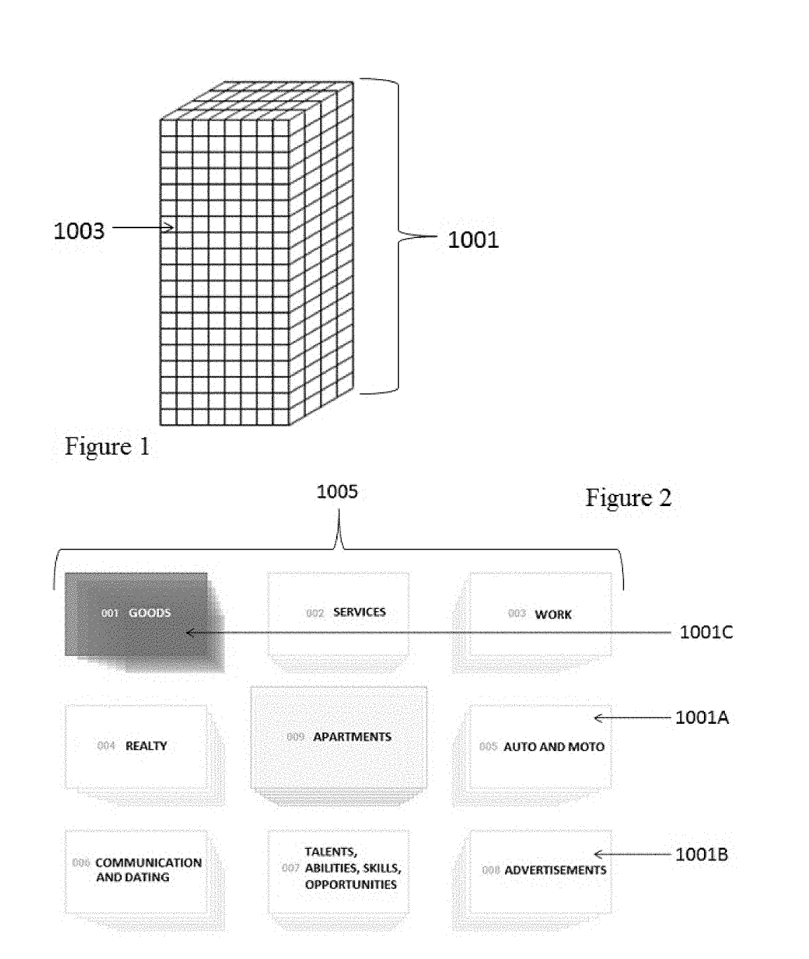

FIG. 1 shows a tower/virtual building 1001 with cells 1003.

FIG. 2 shows a territory 1005, which has a group of towers/virtual buildings 1001A, 1001B and 1001C which include multiple floors. 1001C is a selected tower/virtual building based on a user's request parameter.

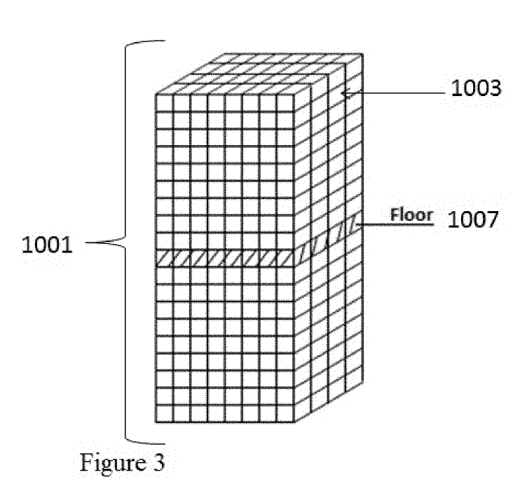

FIG. 3 shows a tower/virtual building 1001 comprised of cells 1003 and cells 1003 being grouped into two-dimensional floors 1007.

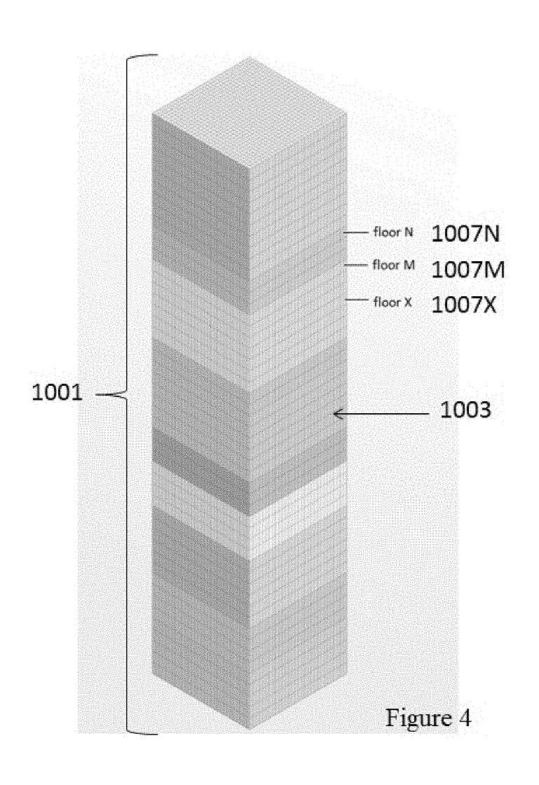

FIG. 4 shows a tower/virtual building 1001 comprised of cells 1003 with three-dimensional floors 1007N, 1007M, and 1007X of varying cell 1003 depths.

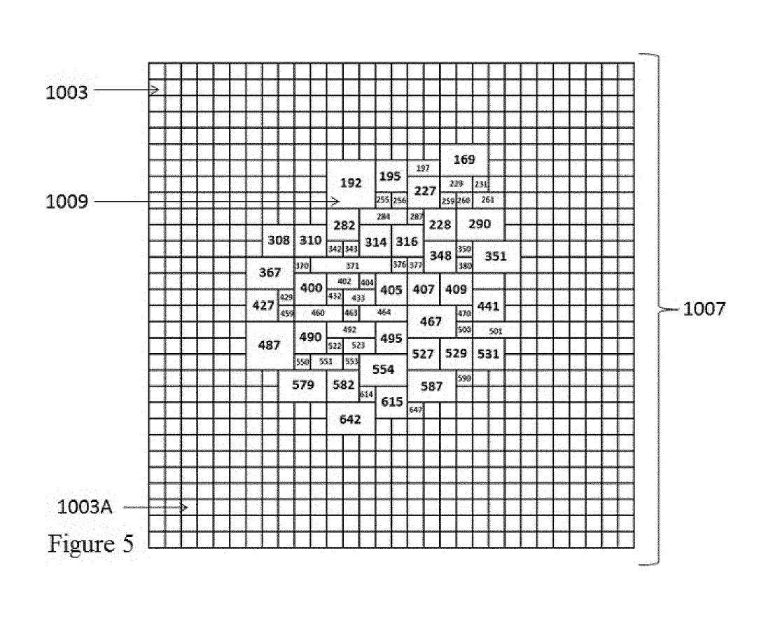

FIG. 5 shows a two-dimensional floor 1007 comprised of cells 1003. Cells 1003 are grouped to form objects 1009 of varying shapes, sizes and with unique number, which assigned to object by the number of upper-left cell.

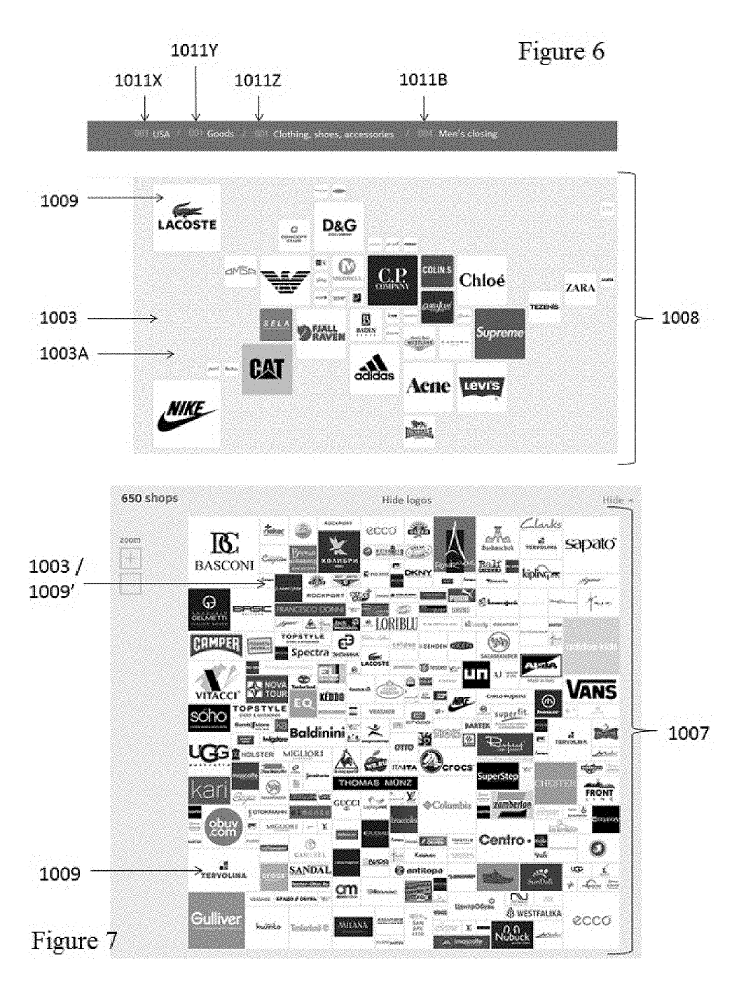

FIG. 6 shows a block 1008 on a two-dimensional floor 1007 comprised of cells 1003 and where the cells 1003 are grouped in various shapes and sizes to make objects 1009. Some cells such as 1003A on a floor 1007 are empty. In this figure the objects 1009 are logos that are relevant to a user's query. Also the unique number for the block 1008 is shown. 1011X denotes a territorial code. 1011Y donates a tower/virtual building code. 1011Z denotes a floor code. And 1011B denotes a block code. In this example the territory is “USA”, the tower/virtual building is “Goods”, the floor is “Clothing, Shoes, Accessories”, and the block is “Men's Clothing”. The XXX-YY-ZZZ-BB-NNN code for the block 1008 shown in FIG. 6 is 001-01-001-04-NNN; NNN because an object/cell has not been selected yet.

Each Cell has an assigned unique, within the Network, number. Cells are numbered in the following manner: XXX-YY-ZZZ-BB-NNN, where: XXX is a code of the territory, to which a Tower belongs (can be symbolic or numeric, can use international numeration systems or systems developed by the Network Administrator); YY is a code of the Tower Purpose; ZZZ is a code of the Tower Floor; BB is a number of the block on the Tower Floor; NNN is a digit number of the Cell in the Floor block. But on FIG. 6 is shown an option for the unique number, where the code of Tower Purpose has 3 symbols and looks like YYY. The code for the block in this example, 1011B, is also three symbols.

FIG. 7 shows a two-dimensional floor 1007 comprised of cells and where the cells 1003 are grouped in various shapes and sizes to make objects 1009. Some objects/logos only take up one cells as in 1003/1009′. Some cells such as 1003A on a floor 1007 are empty. In this figure the objects 1009 are logos that are relevant to a user's query.

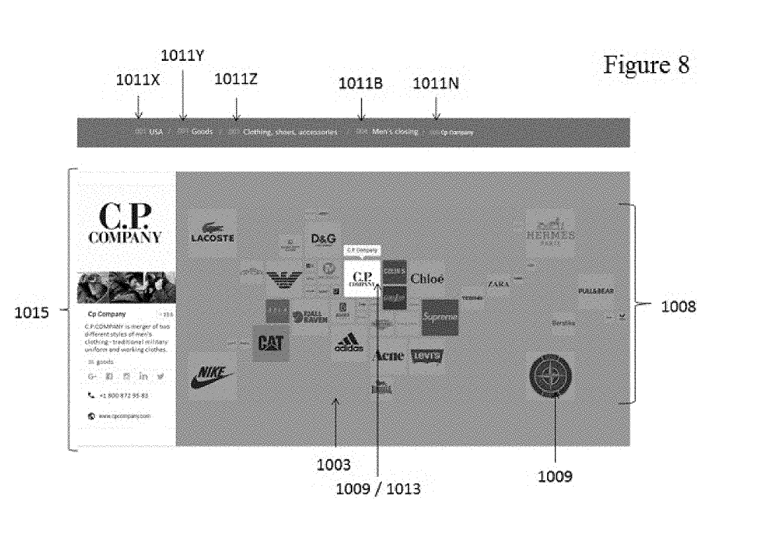

FIG. 8 shows a block 1008 on a two-dimensional floor 1007 comprised of cells 1003 and where the cells 1003 are grouped in various shapes and sizes to make objects 1009. In this figure the objects 1009 are logos that are relevant to a user's query. Also the unique number for the pointed at object 1013 is shown. 1011X denotes a territorial code. 1011Y donates a tower/virtual building code. 1011Z denotes a floor code. 1011B denotes a block code. And 1011N denotes the pointed at object's digit number. In this example the territory is “USA”, the tower/virtual building is “Goods”, the floor is “Clothing, Shoes, Accessories”, the block is “Men's Clothing”, and the pointed at “Cp Company”. The object can be pointed at by a user's finger on a touchscreen enabled device, a stylus, a mouse or cursor, gesture controls, or any other method of pointing at an object on a display. When an object 1009 is pointed at 1013 a preview 1015 for the object is provided.

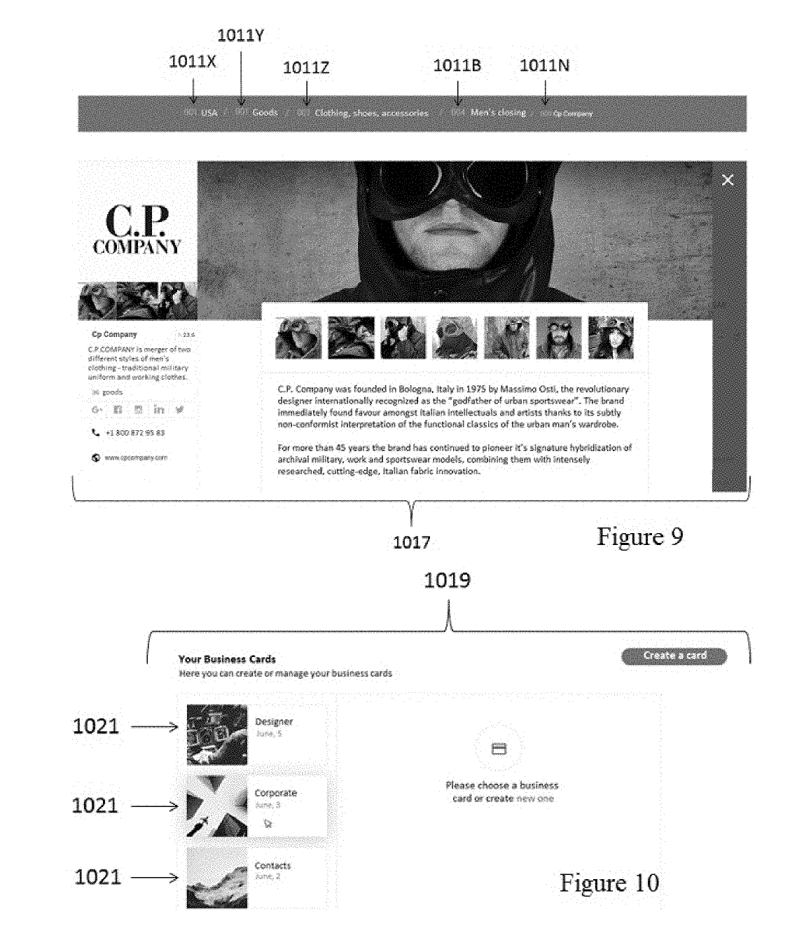

FIG. 9 shows the full information 1017 for a pointed at object 1013 that has been selected by a user. Also the unique number for the selected object is shown. 1011X denotes a territorial code. 1011Y donates a tower/virtual building code. 1011Z denotes a floor code. 1011B denotes a block code. And 1011N denotes the pointed at object's digit number. In this example the territory is “USA”, the tower/virtual building is “Goods”, the floor is “Clothing, Shoes, Accessories”, the block is “Men's Clothing”, and the pointed at “Cp Company”. The object can be pointed at by a user's finger on a touchscreen enabled device, a stylus, a mouse or cursor, gesture controls, or any other method of pointing at an object on a display. When an object 1009 is pointed at 1013 a preview 1015 for the object is provided. Full information 1017 for a selected object may include a bio about the owner of the object, contact information, images, social media, website links, etc.

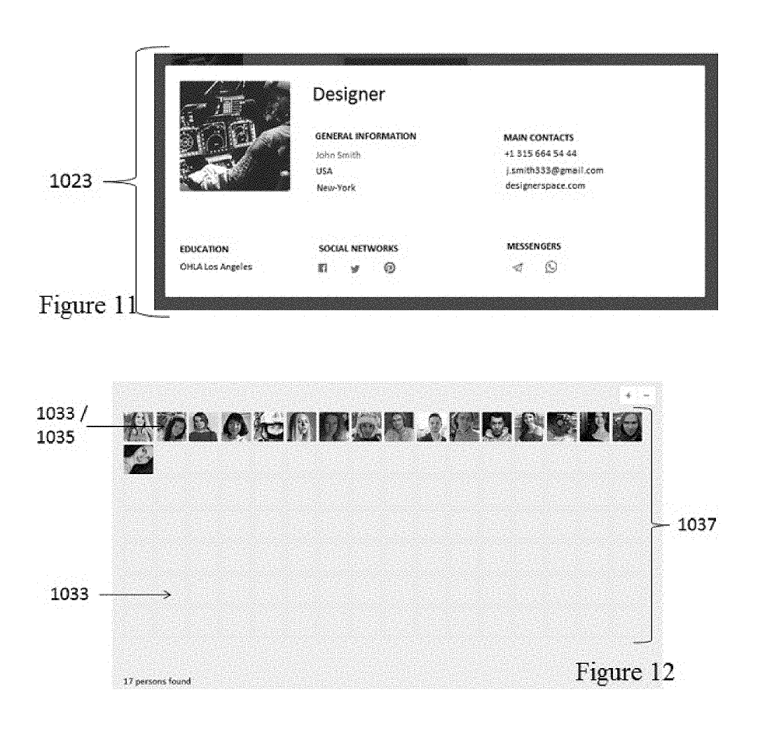

FIG. 10 shows a business card interface. A user can manage or create business cards here. There is also a list of already created business cards 1021.

FIG. 11 shows a dynamic business card 1023 which can contain various information such as general information, contact information, social network links, etc.

FIG. 12 shows a block 1037 in an apartment tower/virtual apartment building (tower “009 Apartments” in FIG. 2), wherein the block 1037 has individual apartments 1033 which may be occupied by individuals using wherein the characteristic image is a photo of the individual 1035.

Each Apartment has its unique address (number) within the Apartment Tower and the Network. The address of the Apartment is formed as follows: XXXXX-YY-NNN, where XXXXX is a code of the Floor in the Apartment Tower; YY is a code of the Apartment block on the Floor; NNN is a number of the Apartment in the Apartment Block. However, the quantity of digits and the composition of blocks in the number format may vary depending on requirements of the Network.

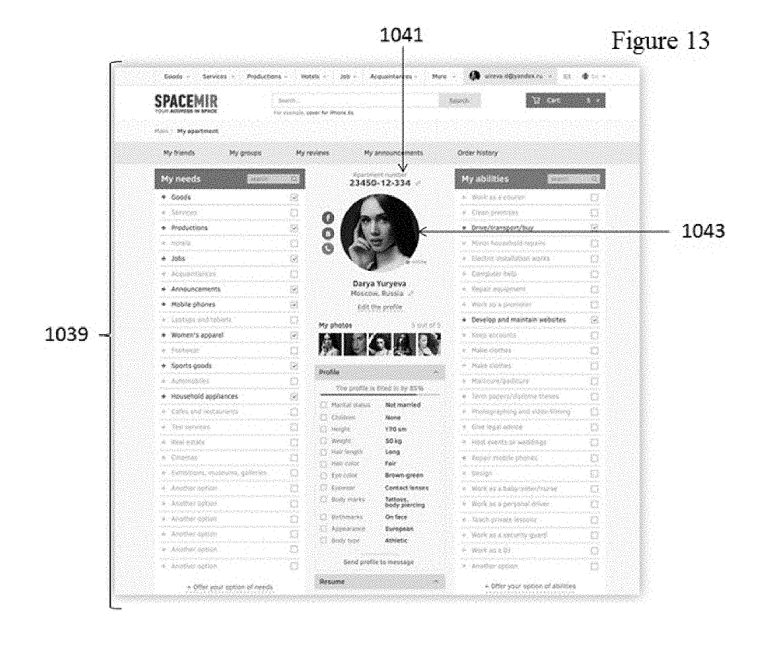

FIG. 13 shows a profile setup interface 1039 for an individual featuring: a unique address number within the apartment tower and network 1041; a phot of the individual 1043; and has user selectable and input information such as needs, abilities, biographical, personal, contact information, additional photos, other files, etc.

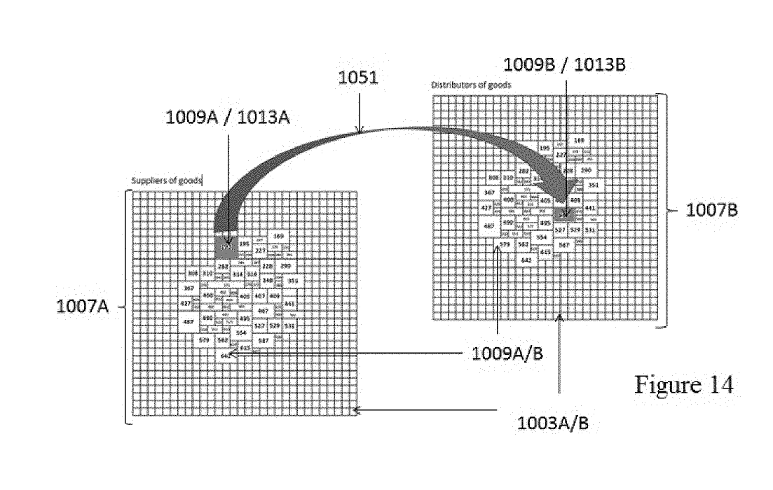

FIG. 14 shows the act of chaining in the present system and method. In the present example as user has made request that includes two types of object such as “suppliers of goods” and “distributors of goods”. The result is two different two-dimensional floor displays 1007A for “Suppliers of Goods” and 1007B for “Distributors of Goods”. Each two-dimensional floor 1007A/B is comprised of cells 1003A/B with groups of cells formed into objects 1009A/1009B. A user selects a supplier of goods 1013A on the first floor 1007A “Suppliers of Goods” and then moves to a second floor 1007B “Distributors of Goods” selecting another object 1013B thus creating a chain 1051 for the user.

The invention is featured by a Chaining mechanism. This mechanism makes it possible to store results of versatile Queries required to satisfy the needs of Network Members in their Private Accounts.

As an example, let us consider a situation, when an Apartment Owner makes repairs with no outside help. Along with purchase of materials, he or she may need an express delivery service in their region and various construction services of different specialists. To address this problem comprehensively, the Apartment Owner, by executing Queries, forms a Chain of Network Objects with information on materials acquired and services ordered in a structured, complex, easy-to-percept and easy-to-process manner. The Chain is stored in the Owner's Apartment and allows viewing the Chain at any time, checking elements of the Chain that fulfilled their purpose, editing initial chaining Queries and deleting the Chain.

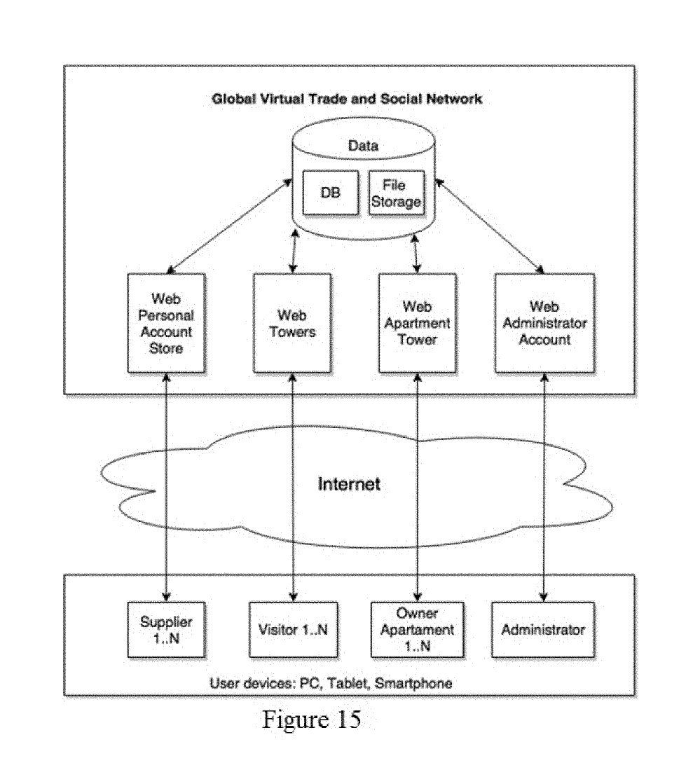

FIG. 15 is a high level system and network view. A user sends a request to a server of the system on the user's interface which is a user device such as a PC, tablet, or smartphone. The requests are sent through a communications network such as the internet. The system determines, using software, based upon the type of user (supplier, visitor, owner of an apartment, or administrator) as to how to handle the query. The system sends the selected data to the user. The data is stored on file storage that is a non-transitory computer readable medium in file storage. The file storage is part of a database. When data is stored and presented it is stored in a system of towers sorted into territories. Each tower has a number of floors with the floors made up of cells. Each cell is of equal size. A single cell or groups of cells can form together to be an object. The objects can contain a logo from a company renting the cells that form the object, or in the case of an apartment building, can contain a photo of an individual. The floors are presented as a two-dimensional group of cells and objects. Floors can also have smaller segments called blocks. FIGS. 6 through 8 and 12 display the floors as a user making a query would see them. FIGS. 9 through 11 and 13 show the further interface levels such as previews, full information, business cards, and individual profiles.

FIG. 15 shows system structure of Network, which realize the Method:

1. The visitors using their devices (PC, tablets, smartphones) access Web-resource (on the Internet) which provides access to Towers of different Purposes and Territoriality. Through this Interface, the visitors surf among the Towers, get information about Suppliers and Goods, place applications for receiving additional information or carry out the transactions. The information receiving and transferring by the User through this interface is stored in the database and file store of the Network.

2. The Visitors, who registered in the Network as Suppliers, using their devices (PC, tablets, smartphones) access Web-resource (on the Internet) which provides access to Supplier Personal Account. Through Personal Account, suppliers manage their Stores (Offices), Goods, receive applications for providing additional information, receive information from other Network members and receive applications for transaction. The information processing through Supplier Personal account is stored in the database and file store of the Network.

3. The visitors, who registered in the Network as Apartment Owners, using their devices (PC, tablets, smartphones) access Web-resource (on the Internet) which provides access to Personal Account of Apartment Owner. Through Personal Account, Apartment Owners manage information about profile settings, Abilities, Needs, share information with the other Network Members (Suppliers, Apartment Owners, Network Administrator), participate in social and net communities, build chains The information processing through Personal Account of Apartment Owner is stored in the database and file store of the Network.

4. The representatives of Network Administrator using their devices (PC) access Web-resource (on the Internet) which implements Personal Account of Network Administrator. The representatives of Network Administrator manage the Network through Personal Account of Network Administrator, including Network Users. The information processing through Personal Account of Administrator is stored in the database and file store of the Network.

5. Interaction of listed Web-resources is implemented through centralized database and file store of the Network.

The technical result enables Visitors to satisfy their needs in the field of commercial and service, production, human and social relations through the functionalities of the Network.

For Suppliers, the Network is a profitable and comfortable environment meant for customer search and marketing of goods and services, partner search, establishment of professional associations and B2B relations. Businessmen can open their own stores or offices and can even build their own shopping centers in the Network and lease them.

The invention is a method and system of visualizing, presenting, and querying data so that it can provide a more even playing field for both searching users and providers of goods and services arranged in a territorial, categorical, floor, block and object view. This avoids the display of information as just a list of results wherein the list may often times not be sorted based on relevancy but rather which supplier has paid the most in order to have their result filter to the top of the list.

Visitor, in their turn, gets all global commercial-service-production relations along with social and human interaction within one platform visualized as a virtual world with countries, cities, professional and other associations, buildings shaped as towers or otherwise, virtual floors, real and virtual categories of goods and services. Thanks to the scope, dimensionality, systematization and commonality forming the background of the Network, consumers can have their needs satisfied to the utmost, which is impossible in other search engines and electronic resources. It is a global, uniform, universal and the most convenient platform for local and international search, purchasing and satisfaction of human needs.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

What is claimed is:

1. A method for a visualization of a request of a user, comprising:
the user opening a website page on a user display;
sending a request from a user computer by choosing options on the website page on the display;
the request is transmitted to a server of a system; the server comprising a data storage;
sending a selected data from the data storage back to the user computer; the selected data being selected by a software; the selected data corresponding to the user request;
the system having virtual buildings with virtual floors; the floors having virtual objects; the objects occupying a number of cells; the selected data consisting of selected objects;
providing at least a two-dimensional floor image shown on the user display; the two-dimensional floor image having images of selected objects; each selected object image occupying a number N of cell images on the user display; all cell images being of equal size;
the object image being a logo or other characteristic image of this particular object;
the user surfing over the object images; each object image providing a preview upon being pointed on it by the user;
upon selecting a preferred preview a full information about the selected object is displayed on the user display; the full information including contact information for the selected object is displayed to the user.

2. The method of claim 1, wherein pointing is by a user finger on the display.

3. The method of claim 1, wherein the cell image is a square.

4. The method of claim 1, wherein the data storage is a non-transitory computer storage medium.

5. The method of claim 1, the objects of the system are rented by businesses providing goods or services.

6. The method of claim 5, wherein the object images having different size: each business occupying a different number of cell images.

7. The method of claim 6, wherein the size of the object image depends on an object rental cost that this business is paying to a system owner; wherein the object rental cost is equal to a rental cost of one cell image multiplied by a number of cells rented by this business.

8. The method of claim 7, wherein a company having K businesses is occupying K objects and its rental cost S is calculated as follows: S=Σₙ₌₁^{k}(Ncₙ*Pc), where Ncₙ is a number of cells for the object image, Pc is a rent price of one cell image for a certain period of time, the period of time selected from a month, a quarter of a year, a half year, and a year and k is a number of network objects rented by the company.

9. The method of claim 1, wherein the buildings correspond to countries.

10. The method of claim 1, wherein the buildings correspond to languages.

11. The method of claim 1, wherein the request describes purchasing of goods or services in vicinity of a given place.

12. The method of claim 1, wherein the request includes at least two types of object requests, and the two-dimensional floor image providing object images of at least first type of objects and the user chooses a second type of objects by moving to a second floor image and pointing on the second type of business on the second floor image; thus forming a chain of requests and their resolutions.

13. The method of claim 1, wherein the objects of the system are occupied by individuals, and each object includes only one cell.

14. The method of claim 13, wherein the request includes free services that an individual needs and the method providing contact information to get in touch with another individual who is offering such service.

15. The method of claim 13, wherein the request includes personal hobbies and abilities of an individual, and the method providing contact information to get in touch with another individual with similar hobbies and abilities.

16. The method of claim 13, wherein the preview displays information selected the individual in a format of dynamic business cards.

17. The method of claim 13, wherein the preview displays information selected by a system.

18. The method of claim 13, wherein the characteristic image is a photo of an individual.

19. The method of claim 1, wherein the user computer is a cell phone with an operating system.

20. The method of claim 1, wherein each of the cells has an assigned unique number within the system, each of the cells are numbered in the following manner: XXX-YY-ZZZ-BB-NNN, wherein XXX is a code of a territory to which the virtual building belongs, wherein YY is a code of the virtual building, wherein ZZZ is a code of the floor; wherein BB is a number of a block on the floor, and wherein NNN is a digit number of the cell in the block on the floor.
